(19) United States
(12) Patent Application Publication
(10) Pub. No.: US 2019/0133159 A1
(43) Pub. Date: May 9, 2019

(54) Uses of Acylated Anthocyanins Extracted from Black Goji (Lycium ruthenicum Murr.) as a Source of Natural Color

(71) Applicant: Ohio State Innovation Foundation, Columbus, OH (US)

(72) Inventors: Monica M. Giusti, Columbus, OH (US); Peipei Tang, Columbus, OH (US)

(73) Assignee: Ohio State Innovation Foundation, Columbus, OH (US)

(21) Appl. No.: 16/096,162

(22) PCT Filed: May 18, 2017
(86) PCT No.: PCT/US17/33290

§ 371 Date: Oct. 24, 2018

Related U.S. Application Data
(60) Provisional application No. 62/340,741, filed on May 24, 2016.

(51) Int. Cl. A23L 5/43; C09B 61/00

(52) U.S. Cl. CPC A23L 5/43; A23V 2002/00; C09B 61/00

(57) ABSTRACT

Described herein are natural food colorant compositions that includes acylated anthocyanins extracted from black goji and at least one buffer solution, methods of making, and products using the same.

### CROSS-REFERENCE TO RELATED APPLICATIONS

This application claims the priority to U.S. Provisional Application No. 62/340,741 filed May 24, 2016, the entire disclosure of which is expressly incorporated herein by reference.

### STATEMENT REGARDING FEDERALLY SPONSORED RESEARCH

This invention was made with no government support, and the government has no rights in the invention

There is increasing interest in the food industry to replace synthetic materials for coloring foods with natural colorants.

Anthocyanins are water-soluble compounds found in certain types of plants such as fruits and vegetables. At least in part due to their wide availability, anthocyanin-containing vegetable and fruit juices and extracts have been used as natural, edible colorants and to produce colorant compositions, in particular, natural red, purple, and blue hue colorant compositions. Acylated anthocyanins, mostly found in vegetables such as red cabbage or eggplant, were considered as candidates for producing blue color; however, the unique vegetable odor often impairs their application in food colorant.

Lycium ruthenicum is a traditional Chinese herb widely distributed in Tibet. The fruit, known as black goji, has a pleasant aroma and flavor, and is popular in traditional Chinese medicine for disease treatment, such as cardiovascular disease and cancer. Until the present invention, however, it has not been considered as a natural food colorant.

There is no admission that the background art disclosed in this section legally constitutes prior art.

### SUMMARY OF THE INVENTION

In a first broad aspect, described herein is a natural food colorant composition that includes acylated anthocyanins extracted from black goji and at least one buffer solution. Depending on the color desired, the pH of the buffer solution ranges from about 3.0 to about 10.0.

For example, when buffer solution has an acidic pH, the composition has a red color; when buffer solution has a pH in the range of about pH 8-pH 9, the composition has a blue color; and, when buffer solution has a pH of about 7, the composition has a purple color.

In certain embodiments, the natural food colorant composition further includes a metal ion or salt thereof.

Various objects and advantages of this invention will become apparent to those skilled in the art from the following detailed description of the preferred embodiment, when read in light of the accompanying drawings.

### BRIEF DESCRIPTION OF THE DRAWINGS

The patent or application file may contain one or more drawings executed in color and/or one or more photographs. Copies of this patent or patent application publication with color drawing(s) and/or photograph(s) will be provided by the U.S. Patent and Trademark Office upon request and payment of the necessary fees.

FIG. 1: Black goji anthocyanins profiles: 1. Pt-3-O-gal-5-O-glu; 2: Pt-3-O-glu-5-O-glu; 3: Dp-3-O-rut-(p-coumaroyl)-5-O-glu; 4: Pt-3-O-rut-(cis p-coumaroyl)-5-O-glu; and, 5: Pt-3-O-rut-(trans p-coumaroyl)-5-O-glu.

FIG. 2: The spectrum of black goji anthocyanin in pHs ranging from pH 3 to pH 10.

FIG. 3: The color of black goji anthocyanin extracts in pHs ranging from pH 3 to pH 10.

FIG. 4: The color of black goji anthocyanin extracts in pHs ranging from pH 3 to pH 10, expressed on CIE a*b* color space.

FIG. 5: Color change of black goji anthocyanin in pHs ranging from pH 3 to pH 10, over 7 days refrigerate storage

FIG. 6: Color stability (ΔE) over 7 days.

FIG. 7: Color and spectrum change after black goji anthocyanin was mixed with Al³⁺.

FIG. 8: Color change of the black goji anthocyanin and Al³⁺ mixture over 28 days.

FIGS. 9A, 9B, 9C: Color change quantification of the mixture over 28 days.

FIG. 10: Structure of petundin-3-rutinoside-5-glucoside.

FIG. 11: Schematic showing metal complexation with acylated anthocyanins.

### DETAILED DESCRIPTION OF THE PREFERRED EMBODIMENT(S)

Throughout this disclosure, various publications, patents and published patent specifications are referenced by an identifying citation. The disclosures of these publications, patents and published patent specifications are hereby incorporated by reference into the present disclosure to more fully describe the state of the art to which this invention pertains.

One of the co-inventors herein has previously invented a high-purity fractionation process for obtaining anthocyanins from fruits and vegetables, Giusti, et al., U.S. Pat. No. 8,575,334, the entire disclosure of which is expressly incorporated herein by reference. Further, such co-inventor has previously invented a method of isolating blue anthocyanin fractions, Robbins, et al., U.S. Pat. No. 9,598,581, along with natural blue anthocyanin-containing colorants, Robbins, et al., US Pub. No. 2016/0015067, and colorant compositions and methods of use, Robbins, et al., US Pub. No. 2017/0000169, the entire disclosures of which are expressly incorporated herein by reference.

It is now shown herein that anthocyanins (which are primarily acylated) isolated from black goji are a good source of natural color. The profile and the color characteristics of the anthocyanins in black goji are thus a new natural color source for the food industry.

The black goji-extract anthocyanins are useful for natural color sources in a wide range of pH conditions, without undesirable flavors or aromas. When complexed with metal, the black goji-extract anthocyanin are stable natural green and blue colorants.

The terms used in this specification generally have their ordinary meanings in the art, within the context of this invention and in the specific context where each term is used. Certain terms are discussed below, or elsewhere in the specification, to provide additional guidance to the practitioner in describing the compositions and methods of the invention and how to make and use them.

As used herein, the use of the word “a” or “an” when used in conjunction with the term “comprising” in the claims and/or the specification may mean “one,” but it is also consistent with the meaning of “one or more,” “at least one,” and “one or more than one.” Still further, the terms “having,” “including,” “containing” and “comprising” are interchangeable and one of skill in the art is cognizant that these terms are open ended terms.

The term “about” or “approximately” means within an acceptable error range for the particular value as determined by one of ordinary skill in the art, which will depend in part on how the value is measured or determined, i.e., the limitations of the measurement system. For example, “about” can mean within 3 or more than 3 standard deviations, per the practice in the art.

As used herein, the term “colorant” refers to any substance that imparts color by absorbing or scattering light at different wavelengths.

As used herein, the term “colorant composition” refers to any composition that imparts color by absorbing or scattering light at different wavelengths.

As used herein, the term “natural colorant” refers to any substance that exists in or is produced by nature or is obtained from a natural source.

As used herein, the term “natural colorant composition” refers to any composition that comprises a colorant that exists in or is produced by nature or is obtained from a natural source.

As used herein, the term “blue colorant” refers to a colorant that reflects light at wavelengths in the region of 450 to 495 nanometers and has a maximum UV/VIS wavelength absorbance ranging from 615 to 635 nanometers.

As used herein, the term “blue colorant composition” refers to a colorant composition that reflects light at wavelengths in the region of 450 to 495 nanometers and has a maximum UV/VIS wavelength absorbance ranging from 615 to 635 nanometers.

As used herein, “maximum absorbance,” “λmax,” or “λₘₐₓ,” refers to the wavelength in nanometers at which the maximum fraction of light is absorbed by a substance, colorant and/or colorant composition.

As used herein, “FD&C Blue No. 1” includes the various names given to the identical synthetic blue colorant, Brilliant Blue FCF and European Commission E133. The lambda max of FD&C Blue No. 1 is 630 nm.

As used interchangeably herein, the terms “color” and “color characteristics” refer to the color properties such as hue, chroma, purity, saturation, intensity, vividness, value, lightness, brightness and darkness, and color model system parameters used to describe these properties, such as Commission Internationale de l′Eclairage CIE 1976 CIELAB color space L*a*b* values and CIELCH color space L*C*h° values. The CIELAB and CIELCH color models provide more perceptually uniform color spaces than earlier color models. In certain embodiments, the colorant compositions of the present disclosure can be analyzed with a spectrophotometer, and CIELAB L*a*b* and CIELCH L*C*h° values can be calculated from the spectral data. The L*a*b* and L*C*h° values provide a means of representing color characteristics and assessing the magnitude of difference between two colors.

As used herein, “hue” or “hue angle” refers to the color property that gives a color its name, for example, red, blue and violet.

As used herein, “chroma” is a color property indicating the purity of a color. In certain embodiments, a higher chroma is associated with greater purity of hue and less dilution by white, gray or black.

As used herein, “value” is a color property indicating the lightness or darkness of a color wherein a higher “value” is associated with greater lightness.

As used herein “admixing,” for example, “admixing a colorant composition of the present disclosure with a food product,” refers to the method where a colorant composition of the present disclosure is mixed with or added to the completed product or mixed with some or all of the components of the product during product formation or some combination of these steps. When used in the context of admixing the term “product” refers to the product or any of its components. Admixing can include a process that includes adding the colorant composition to the product, spraying the colorant composition on the product, coating the colorant composition on the product, painting the colorant composition on the product, pasting the colorant composition on the product, encapsulating the product with the colorant composition, mixing the colorant composition with the product or any combination thereof. The colorant compositions, e.g., those that are admixed with the product, can be a liquid, dry powder, spray, paste, suspension or any combination thereof.

As used herein, “food grade,” refers to any substance, metal ion and/or colorant composition that is of a grade acceptable for use in edible food products.

As used herein, “food product” refers to an ingestible product, such as, but not limited to, human food, animal foods and pharmaceutical compositions.

In certain embodiments, the one or more goji-extracted acylated anthocyanins comprise about 1% to about 100% by weight of the total colorant composition. In certain embodiments, the one or more goji-extracted acylated anthocyanins comprise about 10% to about 90% by weight of the colorant composition. In certain embodiments, the one or more goji-extracted acylated anthocyanins comprise about 20% to about 80% by weight of the colorant composition. In certain embodiments, the one or more goji-extracted acylated anthocyanins comprise about 30% to about 70% by weight of the colorant composition. In certain embodiments, the one or more goji-extracted acylated anthocyanins comprise about 40% to about 60% by weight of the colorant composition. In certain embodiments, the one or more goji-extracted acylated anthocyanins comprise about 1% to about 20%, about 5% to about 15% or about 8% to about 12% by weight of the colorant composition. In certain embodiments, the one or more goji-extracted acylated anthocyanins comprise about 10% by weight of the total colorant composition.

In certain embodiments, the colorant compositions of the present disclosure exhibit increased color stability, e.g., increased red, blue and/or purple color stability.

In certain embodiments, a colorant composition of the present disclosure in solution exhibits color stability, e.g., blue color stability, for a time period greater than about 1 day, greater than about 2 days, greater than about 3 days, greater than about 4 days, greater than about 5 days, greater than about 6 days, greater than about 7 days, greater than about 8 days, greater than about 9 days, greater than about 10 days, greater than about 11 days, greater than about 12 days, greater than about 13 days, greater than about 14 days, greater than about 15 days, greater than about 16 days, greater than about 17 days, greater than about 18 days, greater than about 19 days, greater than about 20 days, greater than about 21 days, greater than about 22 days, greater than about 23 days, greater than about 24 days, greater than about 25 days, greater than about 26 days, greater than about 27 days, or greater than about 28 days.

In certain embodiments, the colorant composition of the present disclosure can further include one or more stabilizers to enhance stability.

Metal Ions

In certain embodiments of the present disclosure, the colorant composition comprises at least one goji-extracted acylated anthocyanins and at least one metal ion or salt form thereof. In certain embodiments, the metal ion can bind to one or more hydroxyl groups present on the goji-extracted acylated anthocyanins molecule, for example, to increase the color stability of the color composition and/or enhance the color of the color composition. In certain embodiments, the metal ion is Al³⁺.

In certain embodiments, the metal ion can be present in the colorant composition as a metal salt. For example, and not by way of limitation, the metal salt can be Al₂(SO₄)₃. In certain embodiments, thereof can be a food grade metal ion or salt form thereof.

In certain embodiments, the concentration of the metal ion (or salt thereof) in the colorant composition can be from about 0.01 times to about 100 times the concentration of anthocyanins. For example, and not by way of limitation, the concentration of the metal ion, or salt form thereof, can be from about 0.01 times to about 10 times the goji-extracted acylated anthocyanins concentration. In certain embodiments, the concentration of the metal ion, or salt form thereof, can be from about 0.01 times to about 10 times, from about 0.01 times to about 8 times, from about 0.01 times to about 5 times, from about 0.01 times to about 3 times, from about 0.01 times to about 2 times, from about 0.01 times to about 1 times, from about 0.01 times to about 0.75 times, from about 0.01 times to about 0.5 times, from about 0.1 times to about 5 times, from about 0.1 times to about 2 times, from about 0.1 times to about 1 times, from about 0.1 times to about 0.75 times, from about 0.1 times to about 0.5 times, from about 0.25 times to about 5 times, from about 0.25 times to about 2 times, from about 0.25 times to about 1 times, from about 0.25 times to about 0.75 times, from about 0.25 times to about 0.5 times the anthocyanin concentration.

In certain embodiments, the concentration of the metal ion, or salt thereof, in the colorant composition can be less than about 0.5 times, about 0.75 times, about 1.0 times, about 1.5 times, about 2.0 times, about 2.5 times, about 3.0 times, about 3.5 times, about 4.0 times, about 4.5 times, about 5.0 times, about 5.5 times, about 6.0 times, about 7.0 times, about 7.5 times, about 8.0 times, about 8.5 times, about 9.0 times, about 9.5 times or about 10.0 times the goji-extracted acylated anthocyanins concentration. In certain embodiments, the concentration of the metal ion, or salt thereof, in the colorant composition can be from about 0.25 to about 0.75 times the goji-extracted acylated anthocyanins concentration. In certain embodiments, the concentration of the metal ion, or salt thereof, in the colorant composition can be about 0.25 times, about 0.5 times, or about 0.75 times the goji-extracted acylated anthocyanins concentration. In certain embodiments, the concentration of the metal ion, or salt form thereof, in the colorant composition is about 1.0 times the goji-extracted acylated anthocyanins concentration. In certain embodiments, the concentration of the metal ion, or salt thereof, in the colorant composition can be equal to or less than about 1.0 times the goji-extracted acylated anthocyanins concentration (i.e., equal to or less than the anthocyanin concentration).

Buffers

In certain embodiments, a composition of the present disclosure comprises at least one goji-extracted acylated anthocyanins and a buffer of a particular pH.

In certain embodiments, a composition of the present disclosure comprises at least one goji-extracted acylated anthocyanins and/or a metal ion, or salt thereof, and/or a buffer solution of a particular pH. Non-limiting examples of buffers useful for creating the pH environment from pH 3-10 include: pH 3-7: citric acid and/or Na₂HPO₄; pH 8: Na₂HPO₄ and/or NaHPO₄; and pH 9-10: sodium carbonate and/or sodium bicarbonate. It is to be understood, however, that similar results can be obtained with other buffers. Other non-limiting examples of the buffer solution include potassium and sodium-based buffers. In certain embodiments, the buffer can include potassium phosphate, tris(hydroxymethyl)-aminomethane, sodium acetate, or combinations thereof.

In certain embodiments, the buffer has a pH of about 1.0 to about 14.0. For example, and not by way of limitation, the pH of the buffer can be from about 3.0 to about 11.0.

Color Characteristics

As embodied herein, color characteristics of the presently disclosed colorant compositions, e.g., blue colorant compositions, can be determined. Such color characteristics can include hue, chroma, purity, saturation, intensity, vividness, value, lightness, brightness and darkness, and color model system parameters used to describe these properties, such as Commission Internationale de l'Eclairage CIE 1976 CIELAB color space L*a*b* values and CIELCH color space L*C*h° values. For example, L*a*b* values consist of a set of coordinate values defined in a three-dimensional Cartesian coordinate system. L* is the value, or lightness, coordinate. L* provides a scale of lightness from black (0 L* units) to white (100 L* units) on a vertical axis, a* and b* are coordinates related to both hue and chroma, a* provides a scale for greenness (−a* units) to redness (+a* units), with neutral at the center point (0 a* units), on a horizontal axis; b* provides a scale for blueness (-b* units) to yellowness (+b* units), with neutral at the center point (0 b* units), on a second horizontal axis perpendicular to the first horizontal axis. The three axes cross where L* has a value of 50 and a* and b* are both zero.

L*C*h° values consist of a set of coordinate values defined in a three-dimensional cylindrical coordinate system. L* is the value, or lightness, coordinate. L* provides a scale of lightness from black (0 L* units) to white (100 L* units) on a longitudinal axis. h° is the hue coordinate. h° is specified as an angle from 0° to 360° moving counterclockwise around the L* axis. Pure red has a hue angle of 0° , pure yellow has a hue angle of 90° , pure green has a hue angle of 180° , and pure blue has a hue angle of 270° . The C* coordinate represents chroma and is specified as a radial distance from the L* axis. C* provides a scale from achromatic, i.e., neutral white, gray, or black, at the L* axis (0 C* units) to greater purity of hue as the coordinate moves away from the L* axis (up to 100 or more C* units).

### EXAMPLES

Certain embodiments of the present invention are defined in the Examples herein. It should be understood that these Examples, while indicating preferred embodiments of the invention, are given by way of illustration only. From the above discussion and these Examples, one skilled in the art can ascertain the essential characteristics of this invention, and without departing from the spirit and scope thereof, can make various changes and modifications of the invention to adapt it to various usages and conditions.

Black goji extracts contained anthocyanins, about 80% of which are acylated anthocyanins. Petunidin-3-rutinoside-5-glucoside derivatives are the major pigments. In acidic pH the black goji-extract acylated anthocyanins exhibit a red color, while a purple color is obtained at pH 7. The solution turns violet-blue color at pH 8-9.

Black goji-extract anthocyanins complexed with a metal ion, for example Al³⁺, leads to a bathochromic shift (21-30 nm), resulting in an enhanced vivid blue hues in pH7-10. The anthocyanin stability is also strengthened with Al³⁺ chelation. The black goji-extract acylated anthocyanins are useful natural color sources in a wide range of pH conditions, without undesirable flavors or aromas.

Anthocyanins were extracted from black goji feed stock and purified using a C-18 cartridge. The anthocyanins were treated with 0-100* Al₂(SO₄)₃ and dissolved in buffers having pH's that ranged from pH 3 to ph10. UV-Vis spectra between 400-700 nm and Hunter CIE lab values (L*a*b*) were obtained after 60 min equilibration and over 28 days refrigerate storage. The color changes were calculated as ΔE. HPLC-PDA-MS analysis was performed to investigate the anthocyanins profile under acidic condition.

Methods:

Black Goji Anthocyanin Extraction and Purification:

Black goji, purchased from Shanghai China, was frozen with liquid nitrogen and grounded using commercial blender. The anthocyanins were extracted using an acetone/chloroform extraction procedure. The filtrated extracts were purified using a Sep-Pak C18 cartridge and collected in acidified water (0.01% HCl).

Quantification of Black Goji-Extract Anthocyanin:

The monomeric anthocyanin content extracted from black goji was determined using a pH differential. Buffer solutions were prepared using 0.1 M potassium chloride at pH 1.0 and 0.4 M sodium acetate at pH 4.5. Absorbance of samples at pH 1.0 and 4.5 were measured at 700 nm and its λmax (512 nm). Experiments were done in triplicates.

Identification of Black Goji-Extract Anthocyanin:

Extracted samples were analyzed by high performance liquid chromatography (HPLC) (Shimadzu, Columbia, Md.) coupled to a SP-M20A Photodiode Array Detector (Shimadzu, Columbia, Md.) and a LCMS-2010EV Liquid Chromatograph Mass Spectrometer. A reverse phase Symmetry C-18 (Sum 4.6*150 mm) column (Phenomenex, Torrance, Calif.) was used. All of the extracts were filtered through a 0.22 um syringe filter (Phenomenex, Torrance, Calif.) before injection into the HPLC. Samples were analyzed using a flow rate of 0.8 ml/min. The linear gradient used in the analysis was from 8% B 0 min-5 min, 8%-15% B 5 min-35 min, 15%-35% B 35 min-37 min, 35%-8% B 37-40 min, 8% B 40-45 min. The mobile phase consisted of solvent (A) 100% acetonitrile and solvent (B) 5% (v/v) formic acid. Anthocyanin elution was monitored at 500-530 nm. Total ion scan and selected ion monitoring (Mass/charge ratios of 271, 287, 303, 301, 317 and 331, corresponding to the most common anthocyanin aglycones) were conducted.

Mixture of black goji-extract anthocyanins with metal:

Black goji-extract anthocyanin was prepared in concentration of 30 uM in buffer from pH 3 to pH 10. Al₂(SO₄)₃ was added to the buffer solutions based on the anthocyanin:metal molar ratio of 1:0, 1:5, 1:10, 1:50, and 1:100.

Spectrum and Color Stability of Black Goji-Extract Anthocyanin:

After 60 min equilibrium, the color characteristics and spectrum of each mixture were analyzed by ColorQuest XE spectrophotometer (data presented in CIE-L*a*b* with 10 degree observer angle, D65 illuminant), and microplate reader (Molecular Devices SpectraMax 190), respectively over 1 month under refrigerated storage condition (4 degree Celsius) in the dark.

Quantification of Monomeric Anthocyanin in Black Goji:

Based on the pH differential method, the absorbances of the black goji-extract sample at its λmax (51 2nm) and 700 nm in pH 1 and pH 4.5 were measured by spectrophotometer. The average monomeric anthocyanin content (expressed as cyaniding-3-glucoside equivalents) in the black goji extract sample was then calculated to be 500±9.17 mg cy-3-glu eq/100 g sample.

Anthocyanin Profiles in the Black Goji Extract Samples:

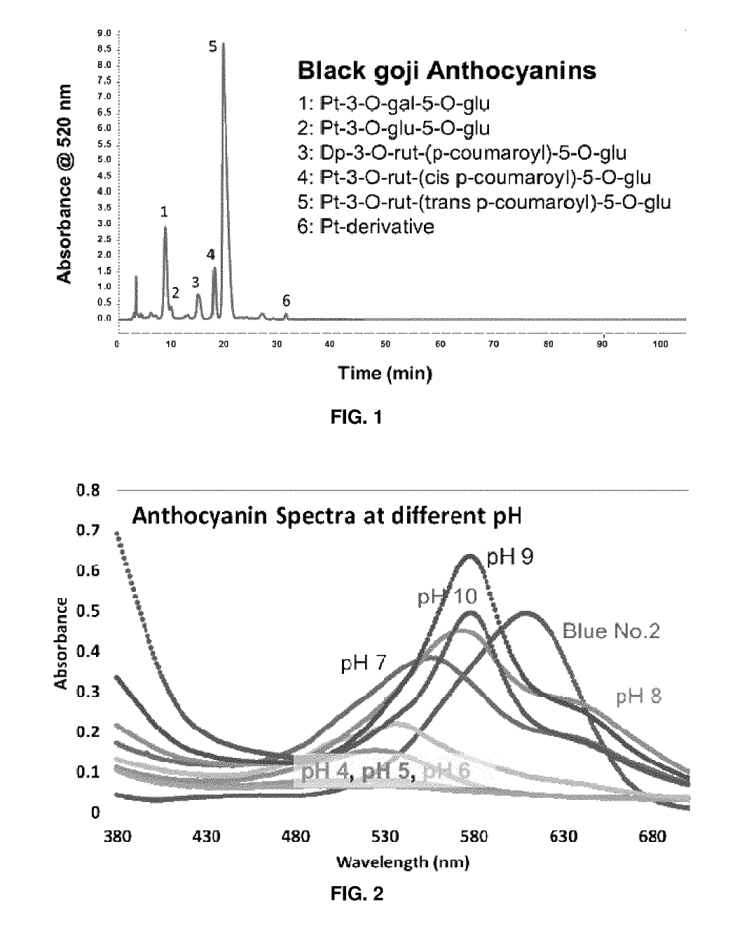

The anthocyanin profile of the black goji extract was prepared by RP-HPLC-PDA-MS (C18 column, mobile phase A acidified water, B acetonitrile). A total of six anthocyanins were separated (FIG. 1). Based on the MS data, the major anthocyanins in the sample were identified to be petunidin-3-rut-5-glu derivatives, petunidin-3-gal-5-glu, and delphinidin-3-rut-5-glu derivatives. About 80% of the anthocyanins were acylated, which are more stable compared to non-acylated ones.

Spectrum and Color Characteristic of Black Goji Anthocyanin

Bathochromic and hyperchromic shifts were observed when the pH of the various black goji-extract anthocyanin solutions increased from acid to alkaline conditions (FIG. 2).

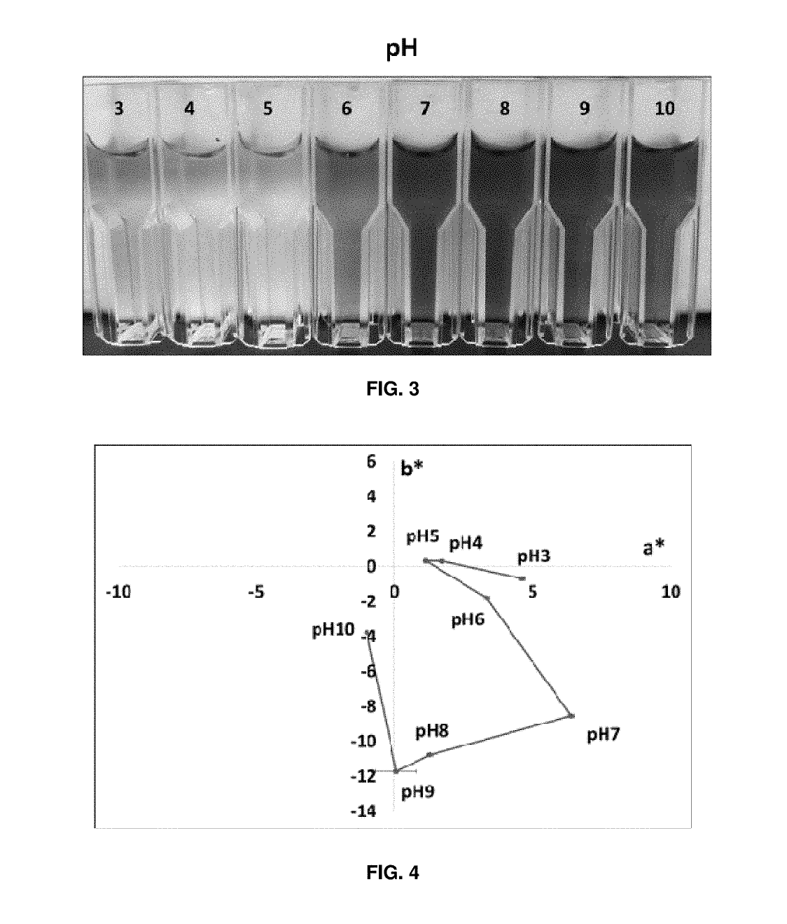

In acidic pH, the black goji-extract anthocyanins exhibits a red color, while a purple color (L*=88.8, a*=6.3, b*=-8.5, λmax=550 nm) is obtained at pH 7. The black goji-extract anthocyanins solution turns a violet-blue color at pH 8-9 (L*=79.2, a*=1.2, b*=−10.7, λmax=571 nm and L*=81.9, a*=0.1, b*=−11.7, λmax=578 nm, respectively). As seen in FIG. 3, the black goji-extract anthocyanins are useful for making natural purple-bluish colorants.

The color change of black goji-extract anthocyanin was also expressed on a CIE a*b* color space: as the pH increases, the position of the color dot traveled from the positive a* value area (red hue) to a large positive b* value area which indicates an intense vivid blue hue (FIG. 4).

Color stability of Anthocyanin in Black Goji Extracts:

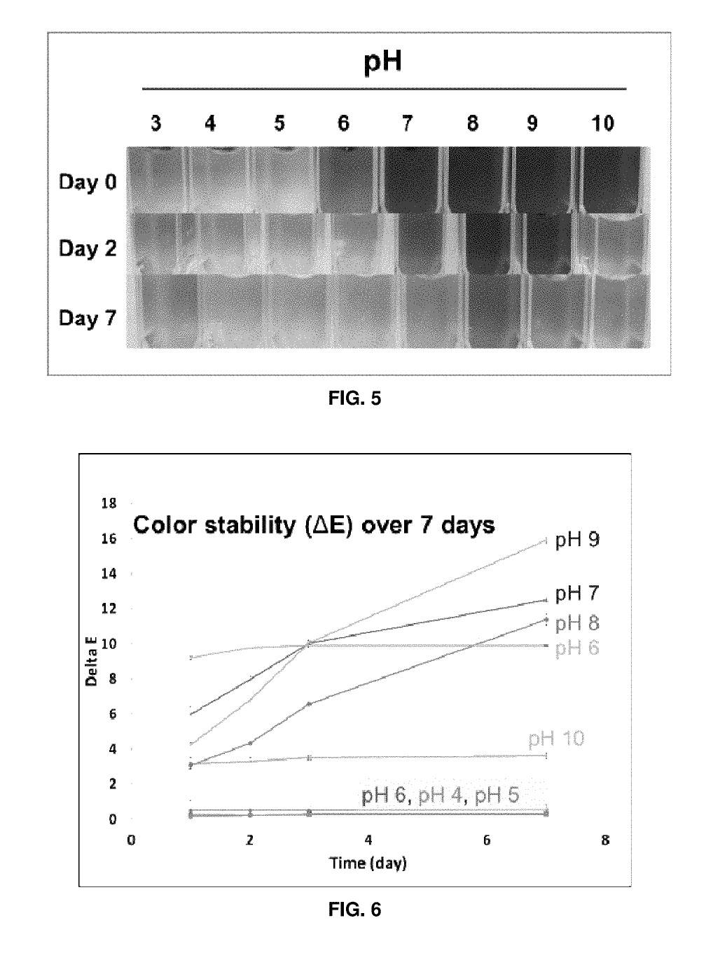

The color of black goji extract was less stable at neutral and alkaline pH. As shown in FIG. 5, the colors in pH 6-pH 10 started to fade on day-2 and became gray or yellow on day-7. Color change (ΔE) was used to quantify the color stability over 7 days. Untrained eyes could notice the color differences when the ΔE is greater than 5. Based on FIG. 6, black goji-extract anthocyanin was only stable for one day under alkaline conditions.

Effect of Metal Chelation on the Color and Spectrum of Black Goji-Extract Anthocyanin:

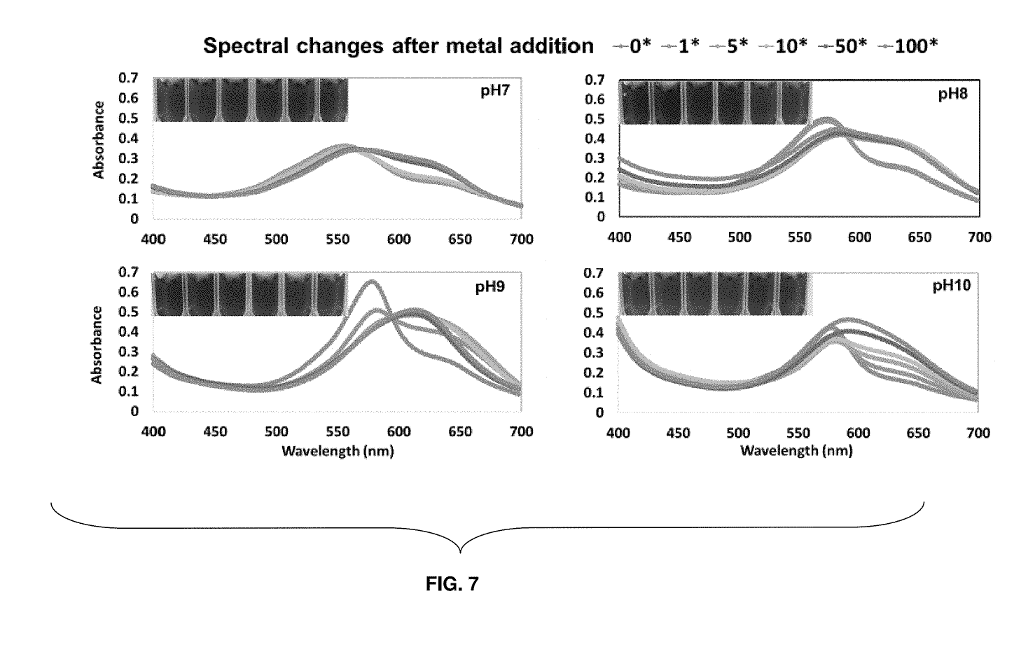

Al³⁺ ion was added to black goji-extract anthocyanin solution based on anthocyanin:metal molar ratio of 1:0, 1:5, 1:10, 1:50, 1:100 in pH7-10. Bathochromic shifts were observed in those pH ranges, resulting in various blue hues from purplish-blue (pH 7), to periwinkle (pH 8), brilliant blue (pH 9), and teal (pH 10) (FIG. 7).

The λmax of the mixture solution in pH 9 reached 610 nm, which was the same as FD&C Blue #2 artificial colorant. Black goji-extract anthocyanin required more metal in neutral pH condition in order to exhibit a blue hue compared to that in an alkaline environment. In pH 10, a green hue was observed in low Al³⁺ concentrations, and it gradually became teal in higher Al³⁺ content.

Color Stability of the Black Goji-Extract Anthocyanin and Al³⁺ Mixtures:

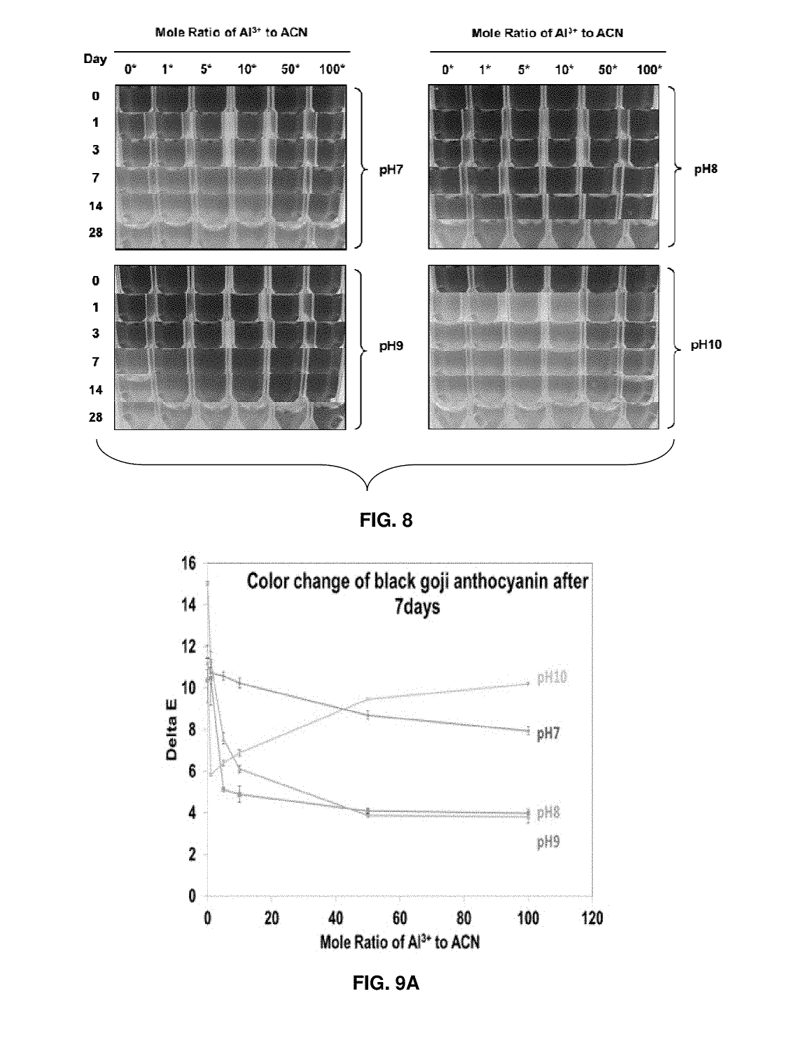

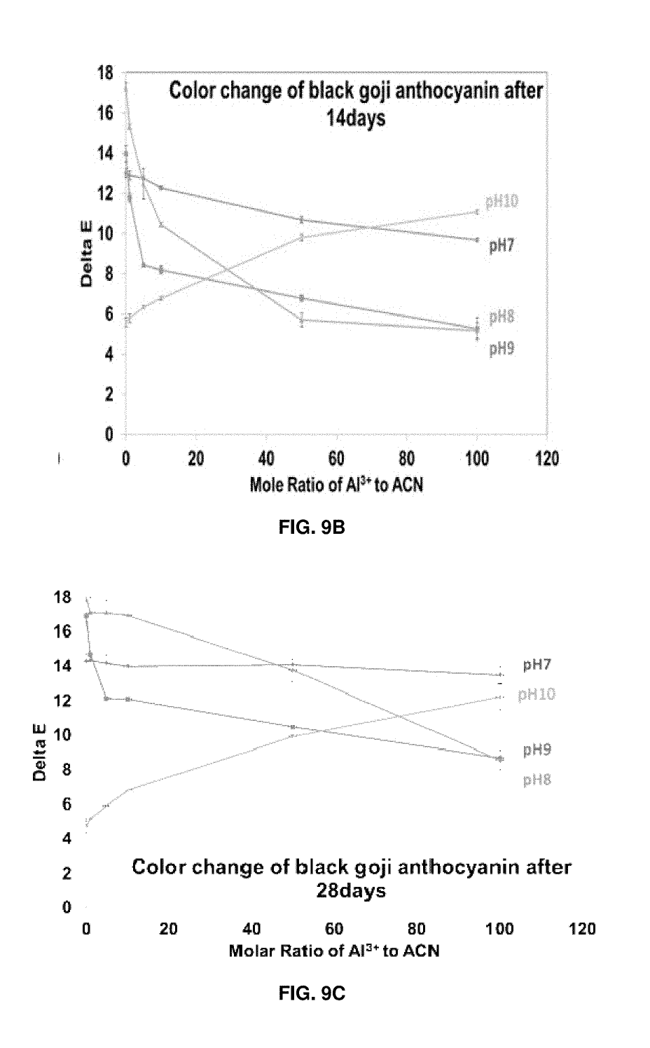

Chelation of Al³⁺ enhanced the color and stability of black goji-extract anthocyanins over 28 days. As shown in FIG. 8 and FIGS. 9A, 9B and 9C, the black goji-extract anthocyanins complexed with metal showed a decreased fading in the color intensity and appearance in pH 7-10. And this stabilization effect is dose-dependent. The black goji-extract anthocyanin-Al³⁺ mixture shows a desirable stability in pH 8 and pH 9 (ΔE was even close to 5 on day 14), while the solutions in pH 7 and pH 10 began to lose color on day 2.

Referring again to FIG. 1, the black goji extract contains about 500 mg anthocyanins/100 g fruit, 80% of which are acylated anthocyanins. As noted above, petunidin-3-rutinoside-5-glucoside derivatives are the major pigments. This is a most unusual discovery, as most fruit contain non acylated anthocyanins, or low proportions of acylated pigments.

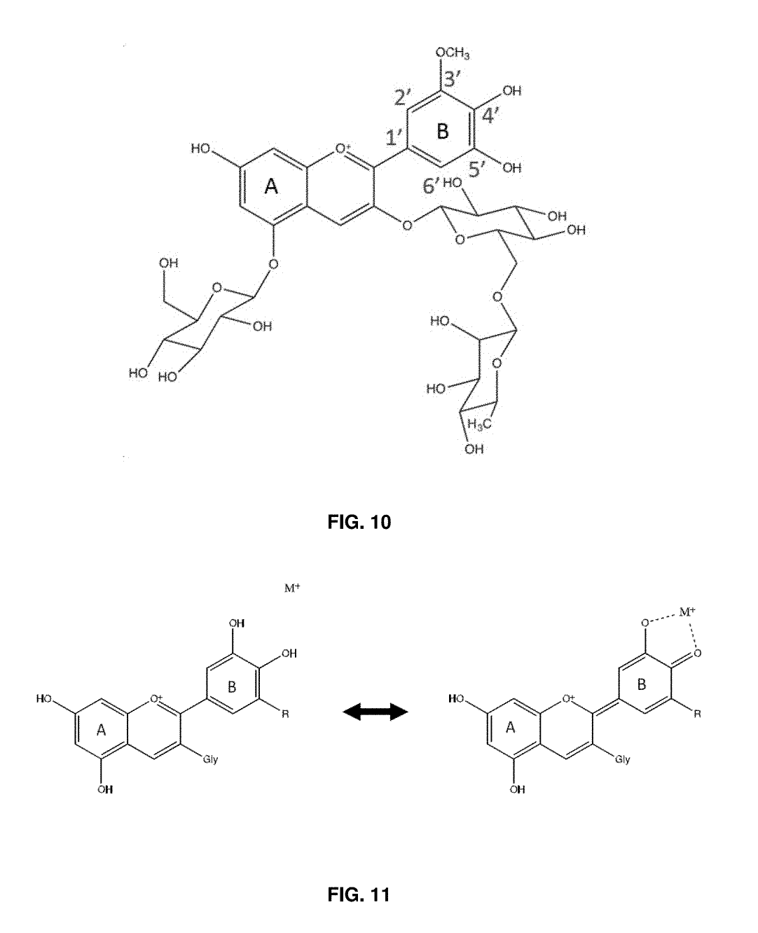

Referring now to FIG. 10, until the present invention, it was believed that the 3′ and 4′ hydroxyl groups on the B ring of anthocyanins were essential for the metal chelation (See FIG. 11). However, as now shown herein, the petunidin derivatives are able to chelate Al³⁺ and produce a blue color with methoxy and hydroxyl groups on position 3′ and 4′.

FIG. 11 is a schematic illustration showing that metal complexation with anthocyanins occurs on the two adjacent hydroxyl groups on the B-ring of cyanidin or delphinidin pigments. The petunidin-derivatives from black goji-extract anthocyanins complexed with Al³⁺ exhibit a bathochromic shift (21-30 nm), resulting in an enhanced vivid blue hue in pH 7-10. The anthocyanin stability was also strengthened with Al³⁺ chelation.

All publications, including patents and non-patent literature, referred to in this specification are expressly incorporated by reference herein. Citation of the any of the documents recited herein is not intended as an admission that any of the foregoing is pertinent prior art. All statements as to the date or representation as to the contents of these documents is based on the information available to the applicant and does not constitute any admission as to the correctness of the dates or contents of these documents.

While the invention has been described with reference to various and preferred embodiments, it should be understood by those skilled in the art that various changes may be made and equivalents may be substituted for elements thereof without departing from the essential scope of the invention. In addition, many modifications may be made to adapt a particular situation or material to the teachings of the invention without departing from the essential scope thereof.

Therefore, it is intended that the invention not be limited to the particular embodiment disclosed herein contemplated for carrying out this invention, but that the invention will include all embodiments falling within the scope of the claims.

What is claimed is:

1. A natural food colorant composition, comprising: acylated anthocyanins extracted from black goji; and, at least one buffer solution, wherein the pH of the buffer solution ranges from about 3.0 to about 10.0.

2. The natural colorant composition of claim 1, wherein, when buffer solution has an acidic pH, the composition has a red color.

3. The natural colorant composition of claim 1, wherein, when buffer solution has a pH in the range of about pH 8-pH 9, the composition has a blue color.

4. The natural colorant composition of claim 1, wherein, when buffer solution has a pH of about 7, the composition has a purple color.

5. The natural food colorant composition of claim 1, wherein the composition further includes a metal ion or salt thereof.

6. The natural colorant composition of claim 5, wherein the metal ion is Al³⁺.

7. The natural colorant composition of claim 1, wherein the buffer solutions comprise: pH 3-7: citric acid and/or Na₂HPO₄; pH 8: Na₂HPO₄ and/or NaHPO₄; and pH 9-10: sodium carbonate and/or sodium bicarbonate.

8. The natural colorant composition of claim 5, wherein Al³⁺ ion is present in the black goji-extract anthocyanin buffer solution based on anthocyanin:metal molar ratio of 1:0, 1:5, 1:10, 1:50, 1:100 in pH 7-10.

9. The natural colorant composition of claim 1, wherein the goji-extracted acylated anthocyanins comprise petunidin-3-rut-5-glu derivatives, petunidin-3-gal-5-glu derivatives, and delphinidin-3-rut-5-glu derivatives.

10. The natural colorant composition of claim 1, wherein the goji-extracted acylated anthocyanins comprise one or more of: Pt-3-O-gal-5-O-glu; Pt-3-O-glu-5-O-glu; Dp-3-O-rut-(p-coumaroyl)-5-O-glu; Pt-3-O-rut-(cis p-coumaroyl)-5-O-glu; and, Pt-3-O-rut-(trans p-coumaroyl)-5-O-glu.

11. The natural colorant composition of claim 1, wherein the natural colorant composition exhibits color stability for greater than about 14 days.

12. A food product, comprising the natural colorant composition of claim 1.

13. A method of preparing a natural colorant composition, comprising: a) obtaining at least one acylated anthocyanin from a black goji; b) diluting the acylated anthocyanin in a buffer solution having a pH of from about 3.0 to about 10.0.

14. The method of claim 13, further comprising admixing a metal ion or salt thereof in the buffer solution.

15. The method of claim 13, wherein the metal ion or salt thereof comprises Al³⁺.

16. An edible product comprising the natural food colorant composition of claim 1.

17. A composition comprising acylated anthocyanins extracted from black goji.

18. The composition of claim 17, wherein the goji-extracted acylated anthocyanins comprise petunidin-3-rut-5-glu derivatives, petunidin-3-gal-5-glu, and delphinidin-3-rut-5-glu derivatives.

19. A substantially purified extract of goji, comprising at least one of: Pt-3-O-gal-5-O-glu; Pt-3-O-glu-5-O-glu; Dp-3-O-rut-(p-coumaroyl)-5-O-glu; Pt-3-O-rut-(cis p-coumaroyl)-5-O-glu; and, Pt-3-O-rut-(trans p-coumaroyl)-5-O-glu.

20. A product comprising the natural food colorant of claim 1, and a food item, a drug or nutraceutical product, or cosmetic product.
